(19) United States
(12) Patent Application Publication
(10) Pub. No.: US 2025/0361034 A1
(43) Pub. Date: Nov. 27, 2025

(54) Hybrid Control Scheme for Aerocapture Maneuver

(71) Applicant: The Charles Stark Draper Laboratory, Inc., Cambridge, MA (US)

(72) Inventor: Thomas Palazzo, Cambridge, MA (US)

(21) Appl. No.: 19/087,865

(22) Filed: Mar. 24, 2025

Related U.S. Application Data
(60) Provisional application No. 63/650,441, filed on May 22, 2024.

(51) Int. Cl. B64G 1/24

(52) U.S. Cl. CPC B64G 1/245

(57) ABSTRACT

A method for inserting a spacecraft into a desired orbit around an astronomical body includes determining control input for the spacecraft as it travels through an atmosphere of the astronomical body to achieve a desired state for the spacecraft when the spacecraft exits the atmosphere of the astronomical body, the determining including determining a bank angle for the spacecraft as the spacecraft travels through the atmosphere of the astronomical body with a substantially fixed angle of attack, determining an updated angle of attack for the spacecraft as the spacecraft travels through the atmosphere of the astronomical body with the determined bank angle, wherein the spacecraft traveling through the atmosphere of the astronomical body with the bank angle and updated angle of attack substantially achieves the desired state for the spacecraft when the spacecraft exits the atmosphere.

### CROSS-REFERENCES TO RELATED APPLICATIONS

This application claims the benefit of U.S. Provisional Application No. 63/650,441 filed May 22, 2024, the entire contents of which are incorporated herein by reference.

### [1] STATEMENT AS TO FEDERALLY SPONSORED RESEARCH OR DEVELOPMENT

This invention was made with government support under 80JSC021F0092 awarded by NASA. The government has certain rights in the invention.

### [2] BACKGROUND OF THE INVENTION

Aerocapture is an orbital maneuver where a spacecraft uses a planet's atmosphere to slow the spacecraft for insertion into a target orbit around the planet. In general, aerocapture uses aerodynamic drag generated as the spacecraft descends into the planet's atmosphere to slow the spacecraft to a speed where it is captured by the planet. The spacecraft then uses a small propulsive burn to insert itself into the target orbit. Because only a small propulsive burn is required to insert the spacecraft into the target orbit, the amount of propellant carried by the spacecraft is reduced. The reduction in propellant carried by the spacecraft results in a less massive spacecraft that can travel at a higher velocity to the planet.

### [3] SUMMARY OF THE INVENTION

During an aerocapture maneuver, the spacecraft is carefully controlled as it travels through the planet's atmosphere. If the angle of entry of the spacecraft into the planet's atmosphere is too steep or if too much energy is dissipated in the planet's atmosphere, the spacecraft risks crashing to the planet's surface. If the angle of entry of the spacecraft into the planet's atmosphere is too shallow or if too little energy is dissipated in the planet's atmosphere, the spacecraft risks overshooting the target orbit.

One technique for controlling the spacecraft during the aerocapture maneuver is bank angle modulation (BAM). BAM varies the spacecraft's bank angle while maintaining a constant angle of attack and angle of sideslip as the spacecraft proceeds through the planet's atmosphere. An alternative technique for controlling the spacecraft is direct force control (DFC). DFC varies the spacecraft's angle of attack and angle of sideslip while maintaining a constant bank angle as the spacecraft proceeds through the planet's atmosphere.

BAM alone may be sufficient for successful aerocapture if conditions at the target planet are nominal (e.g., the density and other properties of the planet's atmosphere are consistent with expectations). But the margin of error when using BAM is small (e.g., due to the narrow range of atmospheric entry angles where aerocapture is possible), and off-nominal conditions can result in the spacecraft failing to insert into its target orbit.

Aspects described herein relate to a hybrid scheme that controls both bank angle (as in BAM) and attack angle (as in DFC) to ensure successful insertion into a target orbit, even in situations where conditions at the target planet are off-nominal.

In a general aspect, a method for inserting a spacecraft into a desired orbit around an astronomical body includes determining control input for the spacecraft as it travels through an atmosphere of the astronomical body to achieve a desired state for the spacecraft when the spacecraft exits the atmosphere of the astronomical body. The determining includes determining a bank angle for the spacecraft as the spacecraft travels through the atmosphere of the astronomical body with a substantially fixed angle of attack, determining an updated angle of attack for the spacecraft as the spacecraft travels through the atmosphere of the astronomical body with the determined bank angle, wherein the spacecraft traveling through the atmosphere of the astronomical body with the bank angle and updated angle of attack substantially achieves the desired state for the spacecraft when the spacecraft exits the atmosphere.

Aspects may include one or more of the following features.

The desired state may be a desired velocity for the spacecraft when the spacecraft exits the atmosphere of the astronomical body and the method may also include determining that a predicted exit velocity associated with the spacecraft traveling through the atmosphere of the astronomical body with the bank angle and fixed angle of attack is outside a predetermined tolerance, and determining the updated angle of attack based on the predicted exit velocity being outside the predetermined tolerance.

The predicted exit velocity may be associated with the spacecraft traveling through the atmosphere of the astronomical body with the bank angle and updated angle of attack inside the predetermined tolerance. The spacecraft may have control surfaces and the method may include determining a switching time representing a time at which the spacecraft switches from having the control surfaces deployed to having the control surfaces retracted. The bank angle and the switching time may be iteratively determined using a predictor-corrector technique. Deploying the control surfaces in the atmosphere of the astronomical body may cause drag on the spacecraft.

The control input may be determined, in part, using a bang-bang optimal control solution. The predetermined tolerance may represent a range of exit velocities where the spacecraft can achieve insertion into the desired orbit. The range of exit velocities where the spacecraft can achieve insertion into the desired orbit may be determined based on an amount of propellant carried by the spacecraft. The spacecraft may enter a first orbit around the planet after exiting the atmosphere of the planet and may expend propellant to move into the desired orbit. The spacecraft may expend propellant at the apoapsis of the first orbit to raise the periapsis of the first orbit, causing the spacecraft to move into the desired orbit.

A velocity of the spacecraft may be reduced as it travels through the atmosphere of the astronomical body. The updated angle of attack may be iteratively determined using a predictor-corrector technique. Iteratively determining the updated angle of attack may include repeatedly integrating a predicted trajectory of the spacecraft and updating a value of the angle of attack based on the integration. Integrating the predicted trajectory of the spacecraft may include determining the predicted state. The updated angle of attack may be chosen as an angle of attack that reduces a difference between the predicted state and the desired state of the spacecraft below a predetermined value.

The control input may be determined using a computing system on the spacecraft. The control input may be determined using a computing system on Earth and transmitted to the spacecraft.

In another general aspect, a system for inserting a spacecraft into a desired orbit around an astronomical body includes a controller for determining control input for the spacecraft as it travels through an atmosphere of the astronomical body to achieve a desired state for the spacecraft when the spacecraft exits the atmosphere of the astronomical body. The determining includes determining a bank angle for the spacecraft as the spacecraft travels through the atmosphere of the astronomical body with a substantially fixed angle of attack, determining an updated angle of attack for the spacecraft as the spacecraft travels through the atmosphere of the astronomical body with the determined bank angle, wherein the spacecraft traveling through the atmosphere of the astronomical body with the bank angle and updated angle of attack substantially achieves the desired state for the spacecraft when the spacecraft exits the atmosphere.

In another general aspect, software embodied on a non-transitory, computer-readable medium includes instructions for causing a computing system to determine control input for insertion of a spacecraft into a desired orbit around an astronomical body. The instructions cause the computing system to determine the control input for the spacecraft as it travels through an atmosphere of the astronomical body to achieve a desired state for the spacecraft when the spacecraft exits the atmosphere of the astronomical body. The determining includes determining a bank angle for the spacecraft as the spacecraft travels through the atmosphere of the astronomical body with a substantially fixed angle of attack, determining an updated angle of attack for the spacecraft as the spacecraft travels through the atmosphere of the astronomical body with the determined bank angle, wherein the spacecraft traveling through the atmosphere of the astronomical body with the bank angle and updated angle of attack substantially achieves the desired state for the spacecraft when the spacecraft exits the atmosphere.

In another general aspect, a method for inserting a spacecraft into a desired orbit around an astronomical body using an aerocapture maneuver includes determining control input for the spacecraft such that the spacecraft's state upon exiting the planet's atmosphere is consistent with the desired orbit, or within the vehicle's capability to propulsively correct its state to achieve the desired orbit (e.g., the spacecraft travels through an atmosphere of the astronomical body, it is controlled to achieve a desired velocity for the spacecraft when the spacecraft exits the atmosphere of the astronomical body). The determining includes determining a bank angle for the spacecraft as the spacecraft travels through the atmosphere of the astronomical body with a substantially fixed angle of attack, determining that a predicted exit velocity associated with the spacecraft traveling through the atmosphere of the astronomical body with the bank angle and fixed angle of attack is outside a predetermined tolerance, and based on determining that the predicted exit velocity is outside the predetermined tolerance, determining an updated angle of attack for the spacecraft as the spacecraft travels through the atmosphere of the astronomical body, wherein the predicted exit velocity associated with the spacecraft traveling through the atmosphere of the astronomical body with the bank angle and updated angle of attack is inside the predetermined tolerance.

In another general aspect, a system for inserting a spacecraft into a desired orbit around an astronomical body using an aerocapture maneuver includes a controller for determining control input for the spacecraft such that the spacecraft's state upon exiting the planet's atmosphere is consistent with the desired orbit, or within the vehicle's capability to propulsively correct its state to achieve the desired orbit (e.g., the spacecraft travels through an atmosphere of the astronomical body, it is controlled to achieve a desired velocity for the spacecraft when the spacecraft exits the atmosphere of the astronomical body). The determining includes determining a bank angle for the spacecraft as the spacecraft travels through the atmosphere of the astronomical body with a substantially fixed angle of attack, determining that a predicted exit velocity associated with the spacecraft traveling through the atmosphere of the astronomical body with the bank angle and fixed angle of attack is outside a predetermined tolerance, and based on determining that the predicted exit velocity is outside the predetermined tolerance, determining an updated angle of attack for the spacecraft as the spacecraft travels through the atmosphere of the astronomical body, wherein the predicted exit velocity associated with the spacecraft traveling through the atmosphere of the astronomical body with the bank angle and updated angle of attack is inside the predetermined tolerance.

In another general aspect, software embodied on a non-transitory, computer-readable medium, the software including instructions for causing a computing system to determine control input for insertion of a spacecraft into a desired orbit around an astronomical body using an aerocapture maneuver, the instructions causing a computing system to determine the control input for the spacecraft such that the spacecraft's state upon exiting the planet's atmosphere is consistent with the desired orbit, or within the vehicle's capability to propulsively correct its state to achieve the desired orbit (e.g., the spacecraft travels through an atmosphere of the astronomical body, it is controlled to achieve a desired velocity for the spacecraft when the spacecraft exits the atmosphere of the astronomical body). The determining includes determining a bank angle for the spacecraft as the spacecraft travels through the atmosphere of the astronomical body with a substantially fixed angle of attack, determining that a predicted exit velocity associated with the spacecraft traveling through the atmosphere of the astronomical body with the bank angle and fixed angle of attack is outside a predetermined tolerance, and based on determining that the predicted exit velocity is outside the predetermined tolerance, determining an updated angle of attack for the spacecraft as the spacecraft travels through the atmosphere of the astronomical body, wherein the predicted exit velocity associated with the spacecraft traveling through the atmosphere of the astronomical body with the bank angle and updated angle of attack is inside the predetermined tolerance.

Among other advantages, some aspects advantageously reduce interplanetary cruise duration by years by permitting a higher cruise velocity than would be possible for a fully propulsive system.

Some aspects advantageously allow for increased science payload due to the reduced need for propellant.

Aspects are advantageously able to adapt to off-nominal conditions at the target planet.

Other features and advantages of the invention are apparent from the following description, and from the claims.

### [4] BRIEF DESCRIPTION OF THE DRAWINGS

FIG. 1 shows a spacecraft being inserted into a target orbit using a hybrid aerocapture control scheme.

FIG. 2 is a schematic block diagram of a hybrid control system.

FIG. 3 shows a spacecraft being inserted into a target orbit using another hybrid aerocapture control scheme.

FIG. 4 is a schematic block diagram of a hybrid control system without an tolerance module.

### [5] DETAILED DESCRIPTION

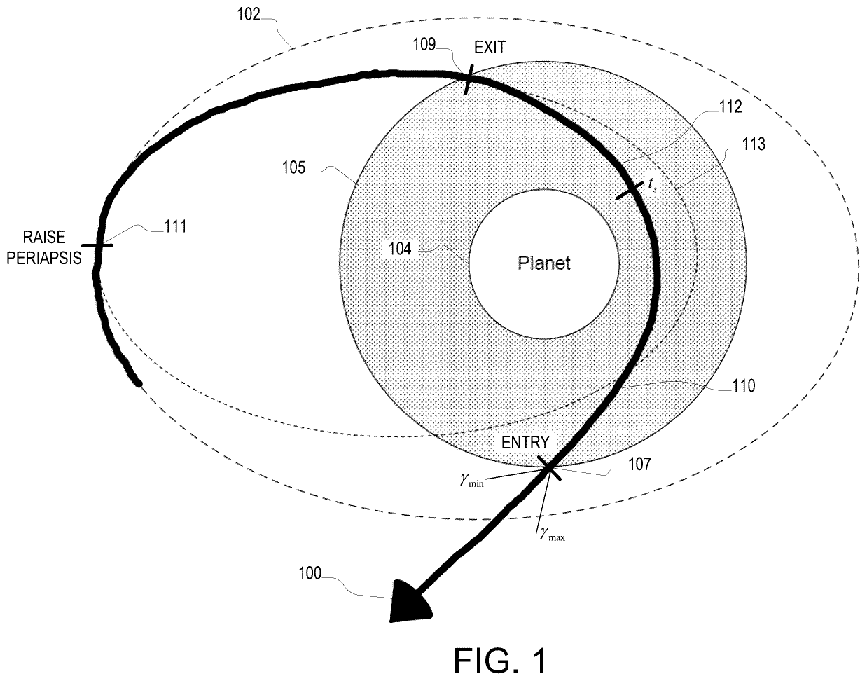

Referring to FIG. 1, a spacecraft 100 is inserted into a target orbit 102 (e.g., a science orbit) around a planet 104 (e.g., Uranus) using a hybrid aerocapture control scheme. As is described in greater detail below, the hybrid aerocapture control scheme controls both a bank angle (i.e., the angle the spacecraft rotates around its velocity vector/direction of travel) and an angle of attack (i.e., the angle between the vehicle's body axis/nose direction and oncoming airflow) of the spacecraft 100 during aerocapture to insert the spacecraft into the target orbit 102 in a way that accounts for off-nominal conditions at the planet 104 (e.g., unexpected atmospheric conditions, variations in entry state, etc.).

### A. AEROCAPTURE

A brief introduction to aerocapture is in order before describing the hybrid aerocapture control scheme in detail. As mentioned above, aerocapture is a control scheme that uses a single pass through a planet's atmosphere to slow a spacecraft from its interplanetary travel velocity and insert the spacecraft into its target orbit with minimal use of propellant.

Initially, the spacecraft 100 approaches the planet 104 at its interplanetary travel velocity, V_{∞}. The spacecraft 100 has a trajectory such that it enters the planet's atmosphere 105 at an entry point 107 at an angle between γₘᵢₙ (i.e., any shallower angle would result in the spacecraft overshooting its orbit) and γₘₐₓ (i.e., any steeper angle would result in the spacecraft crashing to the planet's surface).

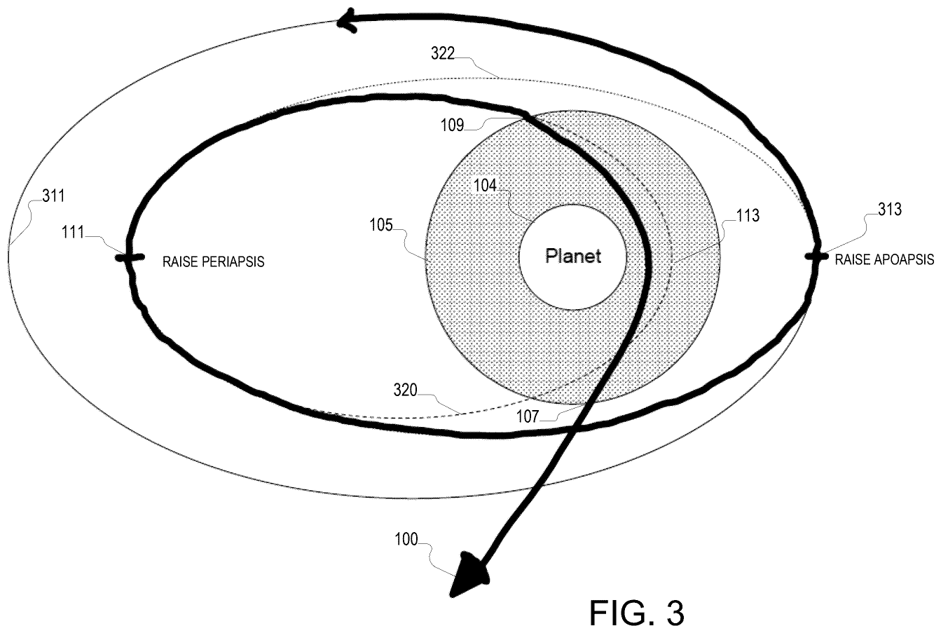

The spacecraft 100 then travels through the atmosphere 105 and aerodynamic drag causes the spacecraft to slow. The spacecraft 100 ultimately exits the atmosphere 105 at an exit point 109 and proceeds to cruise to a first apoapsis 111 (i.e., the point in the spacecraft's orbit about the planet where the spacecraft is furthest from the planet). When the spacecraft 100 reaches the first apoapsis 111, the periapsis 113 of its orbit (i.e., the point in the spacecraft's orbit about the planet where the spacecraft is closest to the planet) is within the atmosphere 105. A periapsis being within the atmosphere 105 would result in the spacecraft eventually crashing to the planet's surface due to atmospheric drag. The spacecraft 100 executes a small propulsive burn in the direction of travel at the first apoapsis 111 to increase the velocity of the spacecraft and raise the periapsis of its orbit out of the atmosphere 105, resulting in the spacecraft being in the target orbit 102. As is described in greater detail below (with reference to FIG. 3), depending on the vehicle's state at the exit point 109, it may be necessary to perform an additional propulsive maneuver to bring the vehicle's final apoapsis in line with mission specification.

Given the limited amount of propellant on the spacecraft 100, there are limits to how much the propulsive burn can change the velocity of the spacecraft (referred to as ΔV) when raising the periapsis. If the ΔV to raise the periapsis would require more propellant than the spacecraft 100 has on board, the mission could be lost. Guidance and control schemes such as bank angle modulation (BAM) and direct force control (DFC) control the spacecraft 100 as it travels through the atmosphere 105 to ensure that the ΔV required to raise the periapsis is in a range that is achievable by the spacecraft 100.

### B. HYBRID AEROCAPTURE CONTROL SCHEME

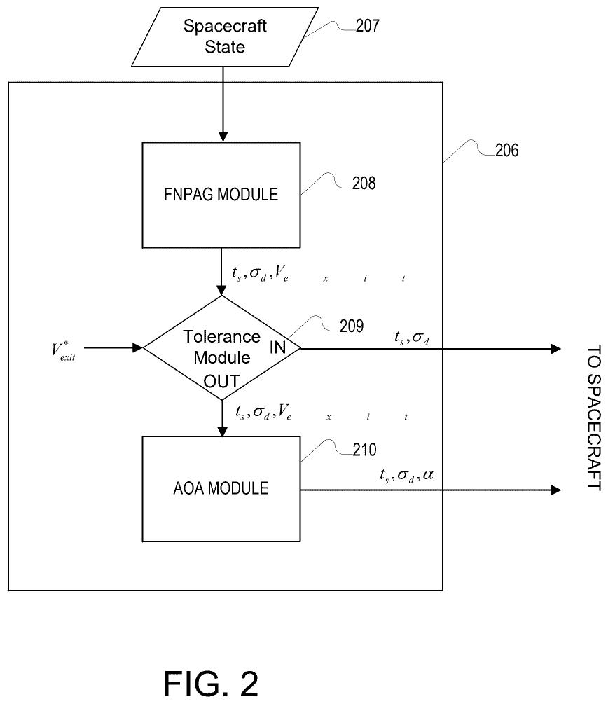

Referring to FIG. 2, the hybrid aerocapture controller 206 is configured to control the spacecraft to achieve a target velocity, Vₑₓᵢₜ* at the exit point 109 from the atmosphere 105, where the target velocity, Vₑₓᵢₜ* ensures that the ΔV required to raise the periapsis is in a range that is achievable by the spacecraft 100 (i.e., the spacecraft has enough propellant on board to achieve the required ΔV). In one example, the hybrid aerocapture controller 206 is implemented as a two-step predictor-corrector that includes a Fully Numerical Predictor-Corrector (FNPAG) module 208, a tolerance module 209, and an Angle of Attack Predictor-Corrector (AoA) module 210. In some cases, the steps can be performed simultaneously, sequentially, or one or more steps may be avoided.

i. Fully Numerical Predictor-Corrector (FNPAG)

Referring now to FIGS. 1 and 2, the FNPAG module 208 receives spacecraft state information 207 (e.g., velocity, trajectory, bank angle, attack angle, etc.). The FNPAG module 208 processes the spacecraft state information 207 to implement an aerocapture guidance and control scheme based on a bang-bang optimal control solution, in which the spacecraft flies full lift up (i.e., with its control surfaces deployed for maximum drag) for a first part 110 of its trajectory through the atmosphere 105. Then, after a switching time, tₛ determined by the FNPAG module 208, the spacecraft flies full lift down (with its control surface retracted) for a second part 112 of its trajectory through the atmosphere 105. The lift-up and lift-down periods define two phases with distinct objectives. In the first phase, the FNPAG module 208 determines the optimal switching time, tₛ that minimizes a chosen objective function (described below) assuming a phase two bank angle of σ_{d}. In phase two guidance solves for a constant bank angle command to minimize the objective function.

In both phases, the FNPAG module 208 functions as a predictor-corrector whereby the switching time or bank angle is iteratively determined by predicting the vehicle's state at atmospheric exit based on the current solution for tₛ (phase 1) or σ_{d} (phase 2), and subsequently correcting it to improve the value of the objective function on the next iteration.

Some approaches to FNPAG formulate aerocapture an apoapsis targeting problem, where guidance attempts to find the control input that minimizes the error in the post-capture apoapsis radius

$${r}_{a} ( {r}_{exit} , {V}_{exit} , {γ}_{exit} ) - {r}_{a}^{*} = 0$$

where rₐ is the post aerocapture orbit's apoapsis radius, rₐ* is the target radius, and rₑₓᵢₜ, Vₑₓᵢₜ and γₑₓᵢₜ are the vehicle's post aerocapture position radius, velocity magnitude, and flight path angle, respectively. Apoapsis targeting is vulnerable to singularities in the solution if the apoapsis radius is negative (i.e., the vehicle remains hyperbolic). In these cases, it is difficult to provide adequate feedback to the on-board guidance to improve its solution.

Rather than minimizing the error in the post-capture apoapsis radius to find the control input, the FNPAG module 208 fixes the exit radius (i.e., the defined termination condition for aerocapture is at a fixed radius) and poses the problem in terms of identifying the target exit velocity, Vₑₓᵢₜ*. This can be derived by computing the energy of the desired orbit

$$∈ * = - \frac{μ}{2 a}$$

where a is the semi-major axis

$$a = \frac{{r}_{a}^{*} + {r}_{p}^{*}}{2}$$

and solving for Vₑₓᵢₜ by holding rₑₓᵢₜ constant

$${V}_{exit}^{*} = \sqrt{μ ( \frac{2}{{r}_{exit}} - \frac{1}{a} )}$$

This eliminates any possible singularities from the cost function, and produces a similar metric to the apoapsis targeting problem whereby the control is derived by solving

$${V}_{exit} - {V}_{exit}^{*} = 0$$

The output of the FNPAG module 208 is the switching time, tₛ, the bank angle σ_{d}, and the predicted value of Vₑₓᵢₜ. It should be noted that this cost function will achieve the desired apoapsis radius when rₐ*>>rₚ*. If this is not the case, targeting a desired exit velocity will only achieve the desired semi-major axis resulting in increased propellant usage when finalizing the post-aerocapture orbit.

ii. Tolerance Module

While the FNPAG module 208 minimizes the difference between the predicted exit velocity, Vₑₓᵢₜ and the target exit velocity, Vₑₓᵢₜ*, it isn't always able to converge on values of tₛ and σ_{d} that minimize the difference to zero. The predicted exit velocity, Vₑₓᵢₜ and the target exit velocity, Vₑₓᵢₜ* are provided to the tolerance module 209, which compares the difference between the two velocities to a tolerance value, Vₜₒₗ (e.g., Vₜₒₗ≤5 m/s) to determine if the predicted exit velocity, Vₑₓᵢₜ is within an acceptable range around the target exit velocity, Vₑₓᵢₜ*.

If the tolerance module 209 determines that the predicted exit velocity, Vₑₓᵢₜ is within an acceptable range around the target exit velocity, Vₑₓᵢₜ*, then the values of tₛ and σ_{d} are used as the control inputs for the aerocapture maneuver. On the other hand, if the tolerance module 209 determines that the predicted exit velocity, Vₑₓᵢₜ is not within an acceptable range around the target exit velocity, Vₑₓᵢₜ*, then the values of tₛ and σ_{d} are provided to the AoA Module 210.

iii. Angle of Attack (AoA) Module

The AoA module 210 determines a new angle of attack for the aerocapture maneuver using a second predictor-corrector step. The second predictor-corrector step initializes two guesses for the new angle of attack at α±δα. For each of those guesses, the AoA module 210 integrates the trajectory forward in time until the exit state to determine a predicted exit velocity, Vₑₓᵢₜ for the guess. If either guess improves the exit velocity, the angle of attack command is updated according to following formula:

$${α}_{k} = {α}_{k - 1} - \frac{{V}_{exit}}{Δ {V}_{exit}} Δ {α}_{k - 1}$$

This process repeats until Vₑₓᵢₜ−Vₑₓᵢₜ* is less than 1 m/s, or after N iterations have occurred. If neither initial guess improves the solution, two new guesses are generated at α±k_{α}δα, and the process repeats until N iterations been completed.

The output of the AoA module 210 is a new value for the angle of attack that, when combined with the switching time, tₛ, the bank angle σ_{d}, controls the spacecraft to achieve the target velocity, Vₑₓᵢₜ* at the exit point 109 from the atmosphere 105, ensuring that the ΔV required to raise the periapsis (and in some examples, the apoapsis) is in a range that is achievable by the spacecraft 100.

### C. ALTERNATIVES

### i. Example of Dual Propulsive Burn

As is noted above, in some examples, depending on the vehicle's state at the exit point 109 it is necessary to perform an additional propulsive maneuver to bring the vehicle's final apoapsis in line with a desired orbit. Referring to FIG. 3, initially, the spacecraft 100 approaches the planet 104 at its interplanetary travel velocity, V_{∞}. The spacecraft 100 has a trajectory such that it enters the planet's atmosphere 105 at an entry point 107.

The spacecraft 100 then travels through the atmosphere 105 and aerodynamic drag causes the spacecraft to slow. The spacecraft 100 ultimately exits the atmosphere 105 at an exit point 109 and proceeds to cruise along a first orbit 320 to a first apoapsis 111 (i.e., the point in the spacecraft's orbit about the planet where the spacecraft is furthest from the planet). The periapsis 113 of the first orbit 320 (i.e., the point in the spacecraft's orbit about the planet where the spacecraft is closest to the planet) is within the atmosphere 105. A periapsis being within the atmosphere 105 would result in the spacecraft eventually crashing to the planet's surface due to atmospheric drag. The spacecraft 100 executes a small propulsive burn in the direction of travel at the first apoapsis 111 to increase the velocity of the spacecraft and move the spacecraft 100 into a second orbit 322 with a periapsis 313 that is raised out of the atmosphere 105.

The spacecraft 100 cruises along the second orbit 322 until it reaches its periapsis 313, where it executes another small propulsive burn in the direction of travel to increase the velocity of the spacecraft and raise the apoapsis of the spacecraft's orbit into its desired orbit 102 with a desired apoapsis 311.

### ii. Controller without Tolerance Module

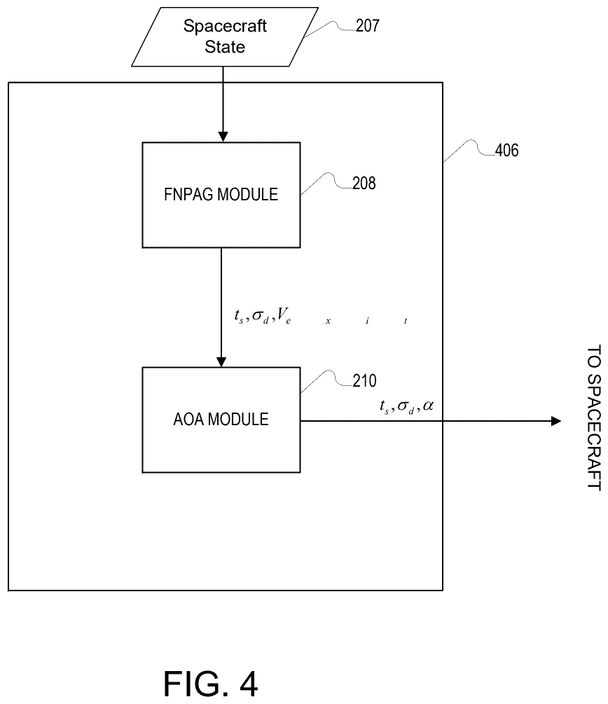

Referring to FIG. 4, as is noted above, another example of the hybrid aerocapture controller 406 operates without a threshold module. In particular, the output of the FNPAG module 208 (i.e., the switching time, tₛ, the bank angle σ_{d}, and the predicted value of Vₑₓᵢₜ) are provided directly to the AoA module 210 without first determining whether the predicted exit velocity, Vₑₓᵢₜ is within an acceptable range around the target exit velocity, Vₑₓᵢₜ*.

The AoA module 210 operates as described above to determine a new (e.g., refined) value for the angle of attack that, when combined with the switching time, tₛ, the bank angle σ_{d}, controls the spacecraft to achieve the target velocity, Vₑₓᵢₜ*.

In yet other embodiments, the order of the FNPAG module 208 and the AoA module 210 could be reversed.

### iii. Other Alternatives

In some approaches, the hybrid control scheme can be implemented with an objective function that minimizes the error in the post-capture apoapsis radius, as described above.

In general, the hybrid control scheme is implemented on board the spacecraft and determines control parameters substantially in real-time during the aerocapture maneuver. In some examples, the spacecraft is a satellite.

It should be understood that the switching time, t described above can occur at any time when the spacecraft is in the atmosphere of the planet.

It should be understood that the hybrid aerocapture scheme described above is used to determine control input for the spacecraft such that the spacecraft's state upon exiting the planet's atmosphere is consistent with the desired orbit or is within the vehicle's capability to correct its orbit to achieve the desired orbit. The exit velocity when the spacecraft leaves the planet's atmosphere is just one type of state that can be used to achieve this goal. For example, the angle of exit from the atmosphere could be used alone or in combination with the exit velocity to achieve the desired orbit.

### D. IMPLEMENTATIONS

The approaches described above can be implemented, for example, using a programmable computing system executing suitable software instructions or it can be implemented in suitable hardware such as a field-programmable gate array (FPGA) or in some hybrid form. For example, in a programmed approach the software may include procedures in one or more computer programs that execute on one or more programmed or programmable computing system (which may be of various architectures such as distributed, client/server, or grid) each including at least one processor, at least one data storage system (including volatile and/or non-volatile memory and/or storage elements), at least one user interface (for receiving input using at least one input device or port, and for providing output using at least one output device or port). The software may include one or more modules of a larger program, for example, that provides services related to the design, configuration, and execution of data processing graphs. The modules of the program (e.g., elements of a data processing graph) can be implemented as data structures or other organized data conforming to a data model stored in a data repository.

The software may be stored in non-transitory form, such as being embodied in a volatile or non-volatile storage medium, or any other non-transitory medium, using a physical property of the medium (e.g., surface pits and lands, magnetic domains, or electrical charge) for a period of time (e.g., the time between refresh periods of a dynamic memory device such as a dynamic RAM). In preparation for loading the instructions, the software may be provided on a tangible, non-transitory medium, such as a CD-ROM or other computer-readable medium (e.g., readable by a general or special purpose computing system or device), or may be delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs), dedicated, application-specific integrated circuits (ASICs), or graphics processing units GPUs (e.g., for efficient execution of large language models or other machine learning/artificial intelligence models). The processing may be implemented in a distributed manner in which different parts of the computation specified by the software are performed by different computing elements. Each such computer program is preferably stored on or downloaded to a computer-readable storage medium (e.g., solid state memory or media, or magnetic or optical media) of a storage device accessible by a general or special purpose programmable computer, for configuring and operating the computer when the storage device medium is read by the computer to perform the processing described herein. The inventive system may also be considered to be implemented as a tangible, non-transitory medium, configured with a computer program, where the medium so configured causes a computer to operate in a specific and predefined manner to perform one or more of the processing steps described herein.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

What is claimed is:

1. A method for inserting a spacecraft into a desired orbit around an astronomical body, the method comprising:
determining control input for the spacecraft as it travels through an atmosphere of the astronomical body to achieve a desired state for the spacecraft when the spacecraft exits the atmosphere of the astronomical body, the determining including:
determining a bank angle for the spacecraft as the spacecraft travels through the atmosphere of the astronomical body with a substantially fixed angle of attack;
determining an updated angle of attack for the spacecraft as the spacecraft travels through the atmosphere of the astronomical body with the determined bank angle;
wherein the spacecraft traveling through the atmosphere of the astronomical body with the bank angle and updated angle of attack substantially achieves the desired state for the spacecraft when the spacecraft exits the atmosphere.

2. The method of claim 1 wherein the desired state is a desired velocity for the spacecraft when the spacecraft exits the atmosphere of the astronomical body, the method further comprising determining that a predicted exit velocity associated with the spacecraft traveling through the atmosphere of the astronomical body with the bank angle and fixed angle of attack is outside a predetermined tolerance, and determining the updated angle of attack based on the predicted exit velocity being outside the predetermined tolerance.

3. The method of claim 2 wherein the predicted exit velocity associated with the spacecraft traveling through the atmosphere of the astronomical body with the bank angle and updated angle of attack is inside the predetermined tolerance.

4. The method of claim 1 wherein the spacecraft has control surfaces and the method further comprises determining a switching time representing a time at which the spacecraft switches from having the control surfaces deployed to having the control surfaces retracted.

5. The method of claim 4 wherein the bank angle and the switching time are iteratively determined using a predictor-corrector technique.

6. The method of claim 4 wherein deploying the control surfaces in the atmosphere of the astronomical body causes drag on the spacecraft.

7. The method of claim 1 wherein the control input is determined, in part, using a bang-bang optimal control solution.

8. The method of claim 2 wherein the predetermined tolerance represents a range of exit velocities where the spacecraft can achieve insertion into the desired orbit.

9. The method of claim 8 wherein the range of exit velocities where the spacecraft can achieve insertion into the desired orbit is determined based on an amount of propellant carried by the spacecraft.

10. The method of claim 9 wherein the spacecraft enters a first orbit around the planet after exiting the atmosphere of the planet and expends propellant to move into the desired orbit.

11. The method of claim 10 wherein the spacecraft expends propellant at the apoapsis of the first orbit to raise the periapsis of the first orbit, causing the spacecraft to move into the desired orbit.

12. The method of claim 1 wherein a velocity of the spacecraft is reduced as it travels through the atmosphere of the astronomical body.

13. The method of claim 1 wherein the updated angle of attack is iteratively determined using a predictor-corrector technique.

14. The method of claim 13 wherein iteratively determining the updated angle of attack includes repeatedly integrating a predicted trajectory of the spacecraft and updating a value of the angle of attack based on the integration.

15. The method of claim 14 wherein integrating the predicted trajectory of the spacecraft includes determining the predicted state.

16. The method of claim 15 wherein the updated angle of attack is chosen as an angle of attack that reduces a difference between the predicted state and the desired state of the spacecraft below a predetermined value.

17. The method of claim 1 wherein the control input is determined using a computing system on the spacecraft.

18. The method of claim 1 wherein the control input is determined using a computing system on Earth and transmitted to the spacecraft.

19. A system for inserting a spacecraft into a desired orbit around an astronomical body, the system comprising:
a controller for determining control input for the spacecraft as it travels through an atmosphere of the astronomical body to achieve a desired state for the spacecraft when the spacecraft exits the atmosphere of the astronomical body, the determining including:
determining a bank angle for the spacecraft as the spacecraft travels through the atmosphere of the astronomical body with a substantially fixed angle of attack;
determining an updated angle of attack for the spacecraft as the spacecraft travels through the atmosphere of the astronomical body with the determined bank angle;
wherein the spacecraft traveling through the atmosphere of the astronomical body with the bank angle and updated angle of attack substantially achieves the desired state for the spacecraft when the spacecraft exits the atmosphere.

20. Software embodied on a non-transitory, computer-readable medium, the software comprising instructions for causing a computing system to determine control input for insertion of a spacecraft into a desired orbit around an astronomical body, the instructions causing a computing system to:
determine the control input for the spacecraft as it travels through an atmosphere of the astronomical body to achieve a desired state for the spacecraft when the spacecraft exits the atmosphere of the astronomical body, the determining including:
determining a bank angle for the spacecraft as the spacecraft travels through the atmosphere of the astronomical body with a substantially fixed angle of attack;
determining an updated angle of attack for the spacecraft as the spacecraft travels through the atmosphere of the astronomical body with the determined bank angle;
wherein the spacecraft traveling through the atmosphere of the astronomical body with the bank angle and updated angle of attack substantially achieves the desired state for the spacecraft when the spacecraft exits the atmosphere.
